(19) United States
(12) Patent Application Publication
(10) Pub. No.: US 2006/0240297 A1
(43) Pub. Date: Oct. 26, 2006

(54) Fuel cell unit and power generating system using the fuel cell unit

(76) Inventors: Kenji Takeda, Hitachi (JP); Masaya Ichinose, Hitachiota (JP); Motoo Futami, Hitachiota (JP); Masahiro Komachiya, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/356,209

(22) Filed: Feb. 17, 2006

(30) Foreign Application Priority Data
Apr. 20, 2005 (JP) 2005-121824

(51) Int. Cl. H01M 8/04

(52) U.S. Cl. 429/22; 429/26; 429/23

(57) ABSTRACT

A fuel cell unit of the present invention has, in a casing, a fuel cell stack in which plural fuel cells are stacked, monitoring means that detects and monitors voltage, temperature, and the like of the fuel cells, and voltage converting means that boosts output voltage of the fuel cell stack and outputs the boosted output voltage to the outside of the unit. The voltage converting means determines an optimum output current on the basis of states such as the voltage, temperature, and the like of the fuel cells that is output from the monitoring means, and increases or decreases the power generation current of the fuel cell stack.

### CLAIM OF PRIORITY

This application claims priority from Japanese application Serial No. 2005-121824, filed on Apr. 20, 2005, the content of which is hereby incorporated by reference into this application.

### FIELD OF THE INVENTION

The present invention relates to a fuel cell unit using a fuel cell, which generates power by utilizing a chemical reaction.

### BACKGROUND OF THE INVENTION

In recent years, a fuel cell is being developed as an energy source with light loads on the environment. For example, it is being examined to use a polymer electrolyte fuel cell (PEFC) as the energy source of a cogeneration system using heat and power or a power source of an electric vehicle.

A fuel cell is a device that obtains electromotive force from the electrochemical reaction between a fuel gas whose main component is hydrogen and an oxidant gas. The electromotive force of each of fuel cells is at most about 0.7V. Consequently, a single fuel cell stack constructed by stacking, generally, tens to hundreds cells is used. The voltage of each of the stacked fuel cells varies according to distributions of density, humidity, and temperature of a fuel gas in the stack, and the voltage deterioration tendency varies among the cells. Since drop in the voltage of each cell may exert an influence on the life of the stack and safety, the power generation current in the fuel cell stack has to be adjusted while the state of each of the cells is monitored. A cell voltage determining unit that monitors the state of each of plural fuel cells is disclosed in JP-A No. 297407/2003 (from paragraph 0038 to paragraph 0042 and FIG. 2).

In designing of a system using a fuel cell stack, a power generation has to be adjusted on the basis of the know-how of the characteristics of power generation of a fuel cell, and it makes designing difficult.

### SUMMARY OF THE INVENTION

An object of the present invention is to provide a fuel cell unit, which solves the problem and facilitates designing of a power generating system using a fuel cell stack.

A fuel cell unit of the present invention in which a fuel cell stack obtained by stacking plural fuel cells is housed in a casing, includes, in the casing, monitoring means that monitors a state of the fuel cells, and voltage converting means that is electrically connected to the fuel cell stack. The voltage converting means has the function of increasing/decreasing power generation current from the fuel cell stack on the basis of the state of the fuel cells monitored by the monitoring means.

According to embodiments of the present invention, a fuel cell unit which can make designing of a power generating system simplified can be provided.

### BRIEF DESCRIPTION OF THE DRAWINGS

FIG. 1 is a diagram illustrating an outline of a fuel cell unit of a first embodiment.

FIG. 2 is a diagram illustrating the configuration of the inside of a casing of the fuel cell unit of the first embodiment.

FIG. 3 is a diagram showing the system configuration of the fuel cell unit of the first embodiment.

FIG. 4 is a diagram showing a state transition at the time of start and stop of the fuel cell unit of the first embodiment.

FIG. 5 is a diagram showing an outline of a fuel cell unit of a second embodiment.

FIG. 6 is a diagram showing an outline of a fuel cell unit of a third embodiment.

FIG. 7 is a diagram showing an outline of another fuel cell unit of the third embodiment.

FIG. 8 is a diagram showing an outline of a power generating system of a fourth embodiment.

### DETAILED DESCRIPTION OF PREFERRED- EMBODIMENTS

The details of embodiments of the present invention will be described hereinbelow with reference to the drawings.

First Embodiment

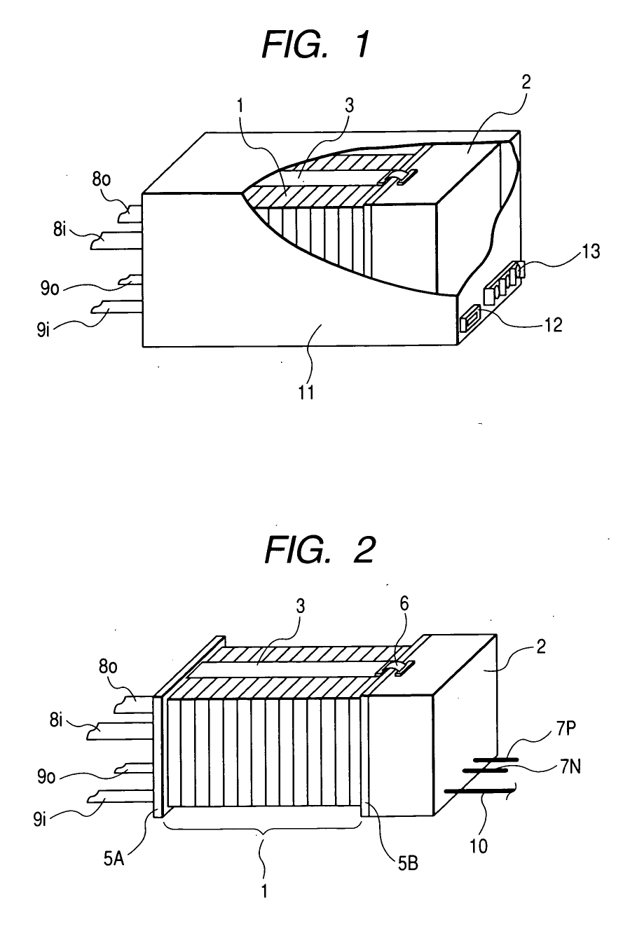

A first embodiment will be described with reference to FIGS. 1 to 4. First, the outline of a fuel cell unit of the embodiment will be described with reference to FIG. 1. In a casing 11 of the fuel cell unit, a fuel cell stack 1 constructed by stacking plural fuel cells, a boost converter 2 as voltage converting means, and a cell state monitoring board 3 as monitoring means are housed.

The shapes of the boost converter 2 and the cell state monitoring board 3 in the casing 11 may be arbitrarily selected according to the dimensions of each of the cells constructing the fuel cell stack 1. On the outer surface of the casing 11, a terminal board 13 as voltage output means and a communication connector 12 as communication means are provided. Although not shown in FIG. 1, a light emitting diode or a liquid crystal panel may be mounted as display means displaying the state of the fuel cell unit on the outer surface of the casing 11.

To the casing 11, fuel supply means 8i for passing hydrogen rich gas as the fuel gas of the fuel cell stack 1, exhaust gas exhausting means 8o that exhausts an exhaust gas after hydrogen as part of the hydrogen rich gas supplied from the fuel supply means 8i is consumed by the fuel cell stack 1, and heating medium supply means 9i and heating medium exhausting means 9o for circulating a heating medium for cooling down heat generated by the fuel cell stack 1 are connected, thereby being connected to a fuel gas system and a heat transfer system on the outside of the casing 11.

In the embodiment, a polymer electrolyte fuel cell is used for the fuel cell stack 1. The casing 11 is made of a metal or resin and is subjected to a necessary insulating process. The casing 11 has an earth terminal. For example, one of the terminals of the terminal board 13 may be used for earthing. As the fuel supply means 8i, exhaust gas exhausting means 8o, heating medium supply means 9i, and heating medium exhausting means 9o, for example, tubes made of a metal or resin are used. Although not shown, oxidant supply means and oxidant exhaust means for supplying and exhausting an oxidant may also be provided for the fuel cell stack 1. For example, tubes made of a metal or resin may be used as the oxidant supply means and the oxidant exhaust means, and air may be supplied as an oxidant.

FIG. 2 shows the internal structure of the fuel cell unit of the embodiment. The fuel cell stack 1 has a configuration in which the fuel cells are staked and both ends are sandwiched by end plates 5A and 5B. Although not shown, the end plates 5A and 5B sandwiching the fuel cells may be fastened by a fastening mechanism such as screws to enhance the sealing performance of the fuel cell stack 1.

The cell state monitoring board 3 is fixed on the surface of the fuel cell stack 1 and monitors the states such as the voltage of each of the cells of the fuel cell stack 1 and the stack temperature. As shown in FIG. 1, the boost converter 2 is disposed so as to be adjacent to one of side faces of the fuel cell stack 1. To the boost converter 2, the cell state monitoring board 3 is connected via a connection cable 6 and, in addition, electrodes 7P and 7N and a communication cable 10 for performing information communications with the outside are connected. The electrodes 7P and 7N are electrically connected to the terminal board 13 mounted on the casing 11, and the communication cable 10 is connected to the communication connector 12 mounted on the casing 11. In place of using the electrodes 7P and 7N, another configuration may be employed in which the terminal board 13 is directly fixed to the boost converter 2, part of the casing 11 is opened, and the terminal board 13 appears in the outer surface of the casing 11 from the opening formed in the casing 11 in a state where the boost converter 2 is housed in the casing 11. Further, to another side face of the fuel cell stack 1, the fuel supply means 8i, exhaust gas exhausting means 8o, heating medium supply means 9i, and heating medium exhausting means 9o are connected. Alternately, a configuration may be employed in which part of another surface of the casing 11 is opened, and the fuel supply means 8i, exhaust gas exhausting means 8o, heating medium supply means 9i, and heating medium exhausting means 9o appear in the outer surface of the casing 11 from the opening formed in the another surface of the casing 11 in a state where the fuel cell stack 1 is housed in the casing 11.

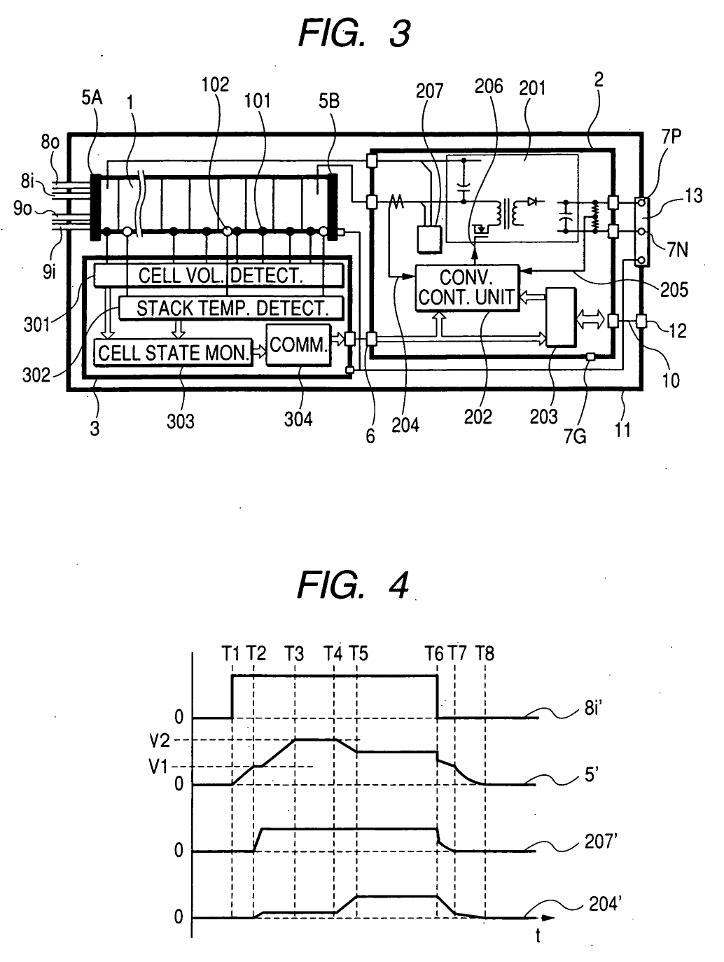

FIG. 3 shows the system configuration of the fuel cell unit housed in the casing 11. Input terminals of the boost converter 2 are electrically connected to the cells at both ends of the fuel cell stack 1. The fuel cell stack 1, boost converter 2, and cell state monitoring board 3 can be electrically connected to the earth terminal provided for the casing 11 as shown by an earth line 7G. As shown in FIG. 3, the boost converter of the embodiment has an electric circuit that temporarily converts an input DC voltage to an AC voltage, rectifies the AC voltage, and outputs a DC voltage.

Each of plural cells, for example, five or six cells in the fuel cell stack 1 or all of the cells has a voltage detection terminal 101. The voltage detection terminal 101 is electrically connected to a cell voltage detector 301 in the cell state monitoring board 3. Similarly, the fuel cell stack 1 has a temperature detector 102, and the temperature detector 102 is connected to a stack temperature detector 302 in the cell state monitoring board 3.

An abnormal state diagnosing process for determining whether the state of the fuel cell stack 1 is normal or abnormal in a stack state monitoring part 303 in the cell state monitoring board 3 on the basis of the information of the cell voltage and the stack temperature obtained by the cell voltage detector 301 and the stack temperature detector 302 and an optimum current instruction value computing process for computing an optimum current instruction value as a power generation current by which the fuel cell can be maintained in a sound state are performed. The abnormal state diagnosis result and the optimum current instruction value obtained in the stack state monitoring part 303 are transmitted to the boost converter 2 via a communication part 304 in the cell state monitoring board 3 and the connection cable 6.

The boost converter 2 has therein a converter main circuit 201, a converter control unit 202, a communication unit 203, and an auxiliary power source 207. The converter control unit 202 computes a converter control pulse 206 on the basis of information of the optimum current instruction value obtained via the connection cable 6, a converter input current detection value 204, and a converter output voltage detection value 205, and outputs the converter control pulse 206 to a power semiconductor switching element in the converter main circuit 201. The communication unit 203 transmits the information of the abnormal state diagnosis result obtained via the connection cable 6 to the outside of the casing 11 by, for example, digital communication or analog communication in a predetermined communication procedure via the communication cable 10 and the communication connector 12. When the voltage across the fuel cell stack 1 becomes equal to or higher than a predetermined threshold V1, the auxiliary power source 207 converts part of generation power of the fuel cell stack 1 and supplies a predetermined voltage such as DC 3.3V, 5V, 12V, or 15V to be consumed by an electric circuit device as a component of the boost converter 2 and the cell state monitoring board 3.

The stack state monitoring part 303 usually outputs a current value at which the power generation output is the highest under the condition that the fuel cell stack 1 can maintain a sound state as an optimum current instruction value.. By performing computation to diagnose an abnormal state by extracting a fluctuation component of a low frequency in fluctuations of a cell voltage, the abnormal state diagnosis can be made while ignoring a voltage drop which can be recovered such as blocking of water in the fuel cell stack 1. Generally, the fuel cell has a characteristic that the cell voltage decreases as the power generation current increases. Consequently, by performing computation so as to temporarily decrease the optimum current instruction value in the case where an arbitrary cell voltage drops abnormally to thereby decrease the input current of the boost converter 2, further drop of the cell voltage can be suppressed and the fuel cell stack 1 can be maintained in a sound state.

In the fuel cell unit of the embodiment having the above-described configuration, the stack state monitoring part 303 determines the optimum current instruction value of the fuel cell stack 1 on the basis of the state of the fuel cells, and the boost converter 2 adjusts the power generation current of the fuel cell stack 1 in accordance with the optimum current instruction value. Therefore, without adjusting the current from the outside of the fuel cell unit, power generation of the fuel cell stack 1 is performed, and designing of the power generation system using the fuel cell stack 1 is facilitated.

Since the fuel cell unit of the embodiment is integrally housed in the casing 11, the insulation distance between the part that generates a voltage such as the fuel cell stack 1 and the outside of the casing 11 can be assured. Consequently, the user is prevented from an electric shock, short-circuiting of a voltage applying part and the like are prevented, and the fuel cell stack 1 can generate power safely.

In the case of electrically serially connecting voltages output to the terminal boards 13 of plural fuel cell units by insulation-type boost converters 2 in each of which the converter main circuit 201 has a transformer in the fuel cell units of the embodiment, it is unnecessary to consider insulation between neighboring fuel cell stacks. Thus, it facilitates assembly.

Since the fuel cell unit of the embodiment can estimate the fuel distribution and the humidity distribution in a cell from the cell voltage of the fuel cell stack 1 and the internal resistance of the cell from the cell temperature, the cell state monitoring board 3 computes the optimum current instruction value while monitoring the voltage and temperature state of the fuel cell stack 1, and drives the boost converter 2 on the basis of the optimum power generation current instruction value. Consequently, the fuel cell stack 1 can maintain the optimum power generation state according to the characteristics of the fuel cells, and degradation of the fuel cell stack 1 and the like caused by excessive power generation or the like can be suppressed.

Moreover, in the fuel cell unit of the embodiment, by supplying power of the auxiliary power source 207 by using a voltage generated by the fuel cell stack 1, power supply from the outside of the fuel power unit becomes unnecessary, so that the number of wires is reduced. In addition, only by passing a fuel gas to the fuel supply means 8i, the fuel cell unit can be automatically started.

In FIGS. 1 to 3, the functions are separated by parts, so that the boost converter 2 and the cell state monitoring board 3 are shown as different blocks. Depending on the layout of the inside of the fuel cell unit, the boost converter 2 and the cell state monitoring board 3 may be disposed in the same block, for example, on the same substrate. It is possible to dispose the boost converter 2 and the cell state monitoring board 3 in the same block and omit the connection cable 6.

FIG. 4 shows transition states at the time of start and stop of the fuel cell unit, and the horizontal axis indicates time. First, at the time of start, a predetermined amount of a fuel gas 8i′ is passed from the outside of the fuel cell unit to the fuel supply means 8i at time T1. Immediately after supply of the fuel, a voltage 5′ across the electrodes at both ends of the fuel cell stack 1 starts rising. From time T2 at which the voltage 5′ reaches the predetermined voltage threshold V1, the auxiliary power source 207 starts driving and supplies a predetermined control voltage 207′. After that, the voltage 5′ continues rising until time T3 at which the voltage 5′ reaches a saturation voltage V2. After the time T3, from time T4 to time T5, power generation current 204′ of the fuel cell stack 1 is increased until it coincides with the optimum current instruction value computed by the cell state monitoring board 3. As the power generation current 204′ increases, the voltage 5′ decreases in accordance with the V-I characteristics of the fuel cell stack 1.

At the time of stop, passage of the fuel gas 8i′ is stopped at time T6. By the stop of the fuel gas 8i′, the voltage 5′ drops. As the voltage 5′ drops, the power generation current 204′ is reduced. At time T6, the power generation current 204′ decreases to the current to be supplied to the auxiliary power source 207. After that, a weak current is continuously passed into the auxiliary power source 207 until time T7 at which the hydrogen gas remained in the fuel cell stack 1 vanishes. As a result, the unit stops. By passing a weak current to the circuit in the auxiliary power source 207 from time T6 to time T7, the operation of the fuel cell unit can be safely stopped without leaving a combustible gas in the fuel cell stack 1.

At the time T3 when the voltage 5′ reaches the saturation voltage V2, the state where power can be generated may be notified to the outside of the fuel cell unit by communication means via the communication connector 12 or the like. The start of time T4 may be determined on the basis of a start trigger sent from the outside via the communication means. By operating the fuel cell unit by using communication with the outside of the fuel cell unit via the communication means, the fuel cell unit can be operated in accordance with the situations of an external circuit connected to the terminal board 13 from the outside of the fuel cell unit. Consequently, an abnormal output such as an over-voltage of the boost converter 2 can be prevented. By mounting a light emitting diode for display on the casing 11 of the fuel cell unit and turning on/off or flashing the light emitting diode on the basis of at least one of the times T1 to T7, for example, also in the case where the state in the unit cannot be determined due to occurrence of abnormality in communication between the fuel cell unit and the outside, the state in the unit can be visually monitored.

Second Embodiment

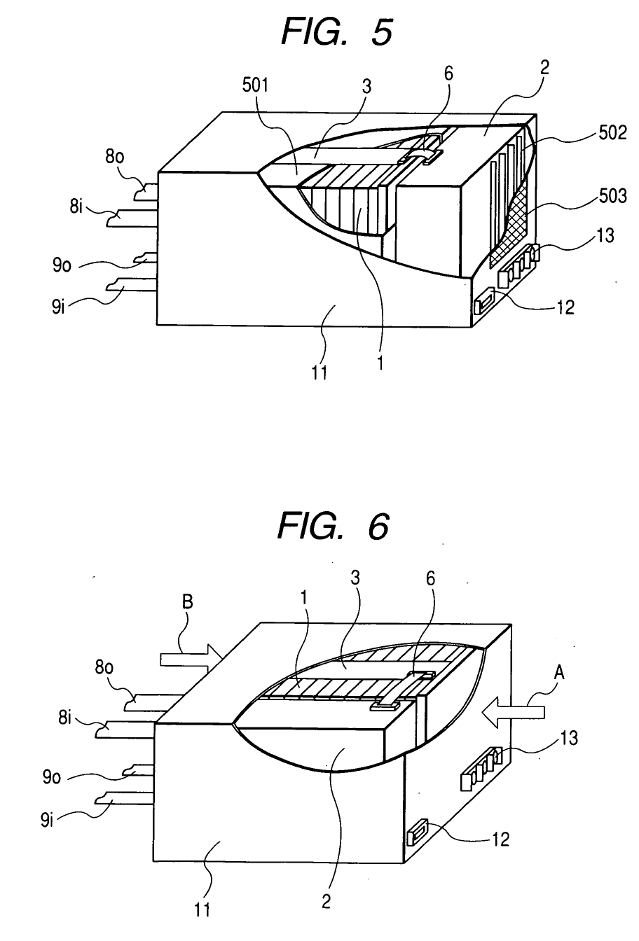

A fuel cell unit of a second embodiment will be described with reference to FIG. 5. The same reference numerals are used for components having the same functions as those of the first embodiment and the detailed description will not be repeated. In the case where the fuel cell stack 1 is, for example, a polymer electrolyte fuel cell stack, the operation temperature at the time of power generation of the fuel cell stack 1 is about 70° C. to 80° C. Consequently, the temperature in the casing 11 of the fuel cell unit rises and there is the possibility that an influence is exerted on an electric circuit device such as the boost converter 2. In the second embodiment, by providing heat insulation means 501 between contacting surfaces of the fuel cell stack 1 and the boost converter 2 and, further, between contacting surfaces of the fuel cell stack 1 and the cell state monitoring board 3, the influence on the electric circuit device in the casing 11 exerted by transmission of heat generated by the fuel cell stack 1 to the inside of the casing 11 can be suppressed.

As the heat insulation means 501, for example, a heat insulating member having heat insulating properties such as glass wool, a thermoelectric material having a thermoelectric effect, an air way through which air passes, or the like can be provided. Temperature rise in the casing 11 can be suppressed by not only the configuration in which the heat insulation means 501 is provided between the contacting surfaces of the fuel cell stack 1 and the boost converter 2 and between the fuel cell stack and the cell state monitoring board 3 but also a configuration in which all of the surfaces of the fuel cell stack 1 are covered with the heat insulation means 501. As shown in FIG. 5, a heat sink 502 as heat discharging means may be provided in a position apart from the fuel cell stack 1 in the boost converter 2. A device whose characteristics deteriorate at high temperature is provided for the heat sink 502, and a vent hole 503 is formed in a part of the surface of the casing 11 facing the boost converter 2, thereby lessening the influence of heat generation of the fuel cell stack 1 on the boost converter 2.

Third Embodiment

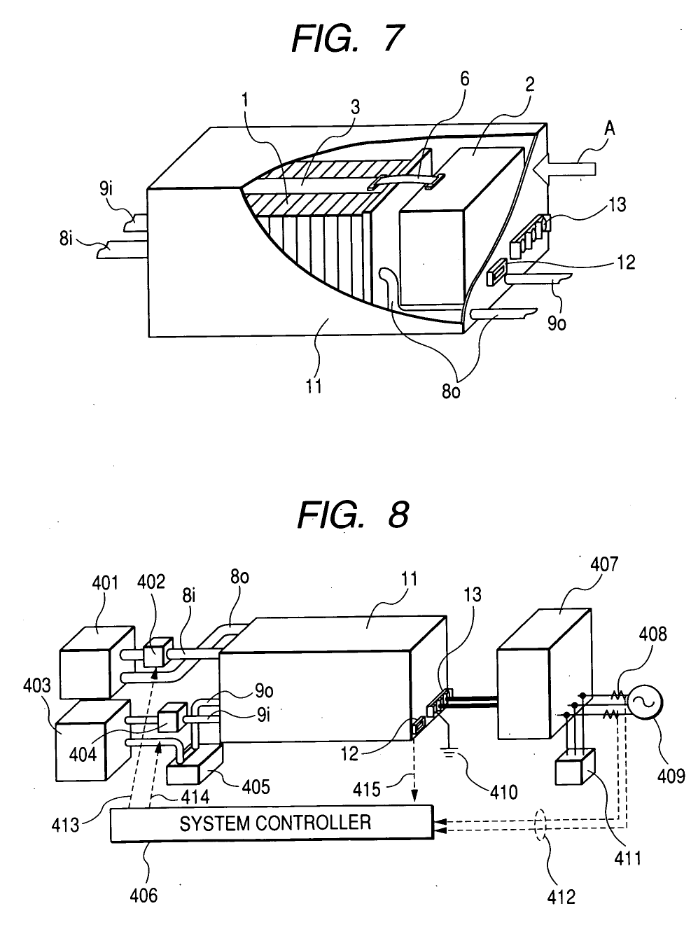

A third embodiment will be described with reference to FIGS. 6 and 7. The same reference numerals are used for components having the same functions as those of the first and second embodiments and the detailed description will not be repeated. In the third embodiment, as shown in FIG. 6, the boost converter 2 is mounted in a position adjacent to the stack surface of the fuel cell stack 1. In FIG. 6, both of the boost converter 2 and the cell state monitoring board 3 are mounted adjacent to the stack surface of the fuel cell stack 1. Further, the functions of the boost converter 2 and the cell state monitoring board 3 may be provided for a single board and provided in a single block.

In the third embodiment, as shown in FIG. 6, the outer shape of the casing 11 of the fuel cell unit is an almost rectangular parallelepiped shape having three sets of two facing surfaces. Systems accompanying connection to the outside, including piping systems such as the fuel supply means 8i, exhaust gas exhausting means 8o, heating medium supply means 9i, and heating medium exhausting means 9o, and electric wiring systems such as the terminal board 13 and the communication connector 12 are concentratedly mounted on a set of facing surfaces as shown by, for example, A and B. With the configuration, in the case of connecting plural fuel cell units in parallel or in series and simultaneously using the units, the fuel cell units can be mounted with surfaces contacted each other except for the surfaces A and B. Thus, the layout space can be reduced and the wiring can be shortened. The space occupied by the piping system which is bent is larger as compared with the electric wiring system.

Therefore, by constructing the casing 11 having a rectangular parallelepiped shape in such a manner that the electric wiring system and the piping system are provided for difference surfaces by connecting pipes to both of a set of facing surfaces, for example, the electric wiring system is provided for the surface A, the piping system is provided for the surface B, and the surfaces A and B face each other, the space occupied by the piping on the side of the surface to which the electric wiring system is connected can be omitted. Thus, the space in the unit connection part can be eliminated or reduced. In addition, the distance between a system of cooling water flowing in the heating medium supply means 9i and the heating medium exhausting means 9o and the terminal board 13 can be increased, so that the possibility of dielectric breakdown between the terminal boards 13 can be avoided even if a water leakage from the cooling water system occurs.

Further, if the surfaces A and B of the casing 11 are a pair of surfaces of the smallest area among the six surfaces constructing the rectangular parallelepiped, the dead space created by connection of the electric wiring system and the piping system can be reduced.

FIG. 7 shows the case where connection points between the exhaust gas exhausting means 8o and the heating medium exhausting means 9o and the fuel cell stack 1 are disposed on the surface which in contact with the boost converter 2. In the case of disposing the electric wiring system and the piping system on the same surface A, as shown in FIG. 7, the layout on the connection surface A of the casing 11 is set so that the piping system is provided along one of sides of the surface A, a line connecting parts of the piping system, that is, a line connecting the center of the exhaust gas exhausting means 8o and the center of the heating medium exhausting means 9o in FIG. 7, and a line connecting the electric wiring system, that is, a line connecting the center of the communication connector 12 and the center of the terminal board 13 in FIG. 7 are disposed in positions which do not cross each other on the surface A. With the configuration, wiring and piping can be facilitated. In the case where the cooling water system is included in the piping system, the electric wiring system is disposed on the upper side of the cooling water system. In such a manner, dielectric breakdown of the electric wiring system is avoided even in the case where a water leakage occurs in the cooling water system.

Fourth Embodiment

A fourth embodiment will be described with reference to FIG. 8. The same reference numerals are used for components having the same functions as those of the first to third embodiments and the detailed description will not be repeated. FIG. 8 shows a power generating system using any of the fuel cell units of the first to third embodiments. A power system interconnected inverter 407 is electrically connected to the electrodes 7P and 7N via the terminal board 13. The power system interconnected inverter 407 inversely transforms power generated in the terminal board 13 to AC power having voltage amplitude and frequency of a power system 409. The AC power obtained by the inverse transformation of the power system interconnected inverter 407 is supplied to the power system 409 or a power system load 411. A ground line 410 is connected to a predetermined earth terminal of the casing 11.

A hydrogen manufacturing apparatus 401 is an apparatus for generating a hydrogen rich gas serving as a fuel of the fuel cell stack 1. A reformer for extracting hydrogen from a city gas, kerosene, or the like, an electrolyzer for electrolyzing water, or the like can be used. The hydrogen rich gas generated by the hydrogen manufacturing apparatus 401 is sent to the fuel supply means 8i by a fuel blower 402. An exhaust gas exhausted from the exhaust gas exhausting means 8o is circulated to the hydrogen manufacturing apparatus and used to collect or burn hydrogen in the exhaust gas. In any of the fuel supply means 8i and the exhaust gas exhausting means 8o, a pipe may be bent downward near the connection point to the casing 11, thereby preventing a droplet formed by condensation of moisture included in the hydrogen rich gas and the exhaust gas from entering the inside of the casing 11. In a cooling water tank 403, a cooling water as a heating medium, which cools heat generated by the fuel cell stack 1 is stored. The cooling water is sent to the heating medium supply means 9i by a cooling water pump 404. For example, water having high purity is used as the cooling water. The cooling water after exchange of the heat of the fuel cell stack 1 is exhausted from the heating medium exhaust means 9o, passes through a heat exchanger 405, and is circulated to the cooling water tank 403.

A system controller 406 gives a fuel blower flow rate instruction 413 and a cooling water pump instruction 414 while monitoring a reception current value 412 detected by a power demand detector 408 disposed between a connection point of the power system interconnected inverter 407 and the power system load 411 and the power system 409, and a unit state signal 415 obtained by the communication connector 12 of the fuel cell unit. By increasing/decreasing the fuel blower flow rate instruction 413 in accordance with increase/decrease in the reception current value 412, the optimum current instruction value in the fuel cell unit changes according to increase/decrease in the fuel, and power obtained from the terminal board 13 increases/decreases. Thus, operation of the power generating system in accordance with a change in the power system load 411 can be performed.

With the configuration, the fuel cell unit has the functions of the optimum current power generation, abnormal state diagnosis, and insulation, so that the power generating system such that designing of assembly of a fuel cell into the system is easy can be constructed.

In the case where the power generated by the fuel cell stack 1 of one fuel cell unit is insufficient for the power system load 411, only by assembling plural fuel cell units in accordance with a use and connecting the terminal boards 13 in series or in parallel, the output capacity of the power generating system can be increased. In the case of assembling plural fuel cell units, there is the possibility that supply of fuel gas to be distributed to the fuel cell units varies. A fuel cell unit to which a small amount of fuel gas is supplied suppresses an output by itself to thereby prevent excessive power generating operation, and all of the fuel cell stacks 1 can be maintained in a sound state. Thus, longer life of the power generating system obtained by assembling the plural fuel cell units can be realized.

In the case of assembling plural fuel cell units, for example, with respect to communication of the unit state signal 415, each of the fuel cell units is allowed to select to be a master or slave. To the system controller 406, a wire for communication only from a fuel cell unit that selects to be a master may be connected.

What is claimed is:

1. A fuel cell unit in which a fuel cell stack constituted by stacking a plurality of fuel cells is housed in a casing, comprising:
monitoring means that monitors a state of the fuel cell and outputs signals representing the state of the fuel cell; and
voltage converting means that is electrically connected to the fuel cell stack and receives signals representing a power generation current which is output from the fuel cell stack,
wherein the monitoring means and the voltage converting means are provided in the casing, and
wherein the voltage converting means receives signals representing the state of the fuel cells that are output from the monitoring means, thereby to increase or decrease the power generation current output from the fuel cell stack.

2. The fuel cell unit according to claim 1, which further comprises fuel supply means that supplies a fuel gas to the fuel cell stack, exhaust gas exhausting means that exhausts a fuel exhaust gas exhausted from the fuel cell stack, heating medium supply means that supplies a heating medium which exchanges heat generated by the fuel cell stack, and voltage output means that supplies output power of the voltage converting means are disposed in the casing.

3. The fuel cell unit according to claim 1, wherein the voltage converting means has an electric insulating means between an input side for receiving the power generation current of the fuel cell stack and an output side of the voltage converting means.

4. The fuel cell unit according to claim 3, wherein the voltage converting means has a transformer and a semiconductor device, temporarily converts an input DC voltage to an AC power, rectifies the AC power, and outputs a DC voltage.

5. The fuel cell unit according to claim 1, wherein the monitoring means monitors voltage and/or temperature of the fuel cells.

6. The fuel cell unit according to claim 1, wherein part or all of power for the monitoring means and the voltage converting means is supplied from the fuel cell stack.

7. The fuel cell unit according to claim 1, wherein at least one of communication means and display means is provided for the casing, and the state of the fuel cell stack is notified to the outside of the fuel cell unit via the communication means or display means.

8. The fuel cell unit according to claim 1, wherein communication means is provided for the casing, and supply of power output from the voltage converting means is started or stopped on the basis of communication on the outside of the fuel cell unit performed via the communication means.

9. The fuel cell unit according to claim 1, wherein the fuel cell stack and the voltage converting means are disposed in the casing via heat insulating means.

10. The fuel cell unit according to claim 1, wherein an air hole through which air can be passed to the voltage converting means disposed in the casing is formed to the casing.

11. A fuel cell unit in which a fuel cell stack constituted by stacking a plurality of fuel cells is housed in a casing, wherein
voltage converting means that receives a power generation current which is output from the fuel cell stack is disposed in the casing, and
fuel supply means that supplies a fuel gas to the fuel cell stack, an exhaust gas exhausting means that exhausts a fuel exhaust gas exhausted from the fuel cell stack, and voltage output means that supplies an output power of the voltage converting means are provided for two facing surfaces or one surface of the casing.

12. The fuel cell unit according to claim 11, wherein the casing has a rectangular parallelepiped shape having three sets of two surfaces facing each other, and the fuel supply means, the exhaust gas exhausting means, and the voltage output means are provided for two facing surfaces having the smallest area among the three sets or one surface of the two facing surfaces having the smallest area.

13. The fuel cell unit according to claim 12, wherein the fuel supply means, the exhaust gas exhausting means, heating medium supply means, and heating medium exhausting means are provided for the same surface in the casing.

14. The fuel cell unit according to claim 11, wherein the fuel cell is a polymer electrolyte fuel cell.

15. A power generating system using a fuel cell unit comprising a power system interconnected inverter connected to a commercial alternate current power system and a fuel cell unit connected to a direct current side of the power system interconnected inverter,
wherein the fuel cell unit comprises, in a casing:
a fuel cell stack in which a plurality of fuel cells are stacked;
monitoring means that monitors a state of the fuel cells and outputs signals representing the state of the fuel cells; and
voltage converting means that is electrically connected to the fuel cell stack and receives signals representing a power generation current which is output from the fuel cell stack, and
the voltage converting means receives the state of the fuel cell that is output from the monitoring means, thereby to increase or decrease the power generation current to be output from the fuel cell stack.

16. The power generating system using a fuel cell unit according to claim 15, which comprises a plurality of fuel cell units, and output voltages of the voltage output means of the plurality of fuel cell units are electrically connected in series or in parallel.

17. The power generating system using a fuel cell unit according to claim 16, wherein the plurality of fuel cell units output powers different from each other.
